(19) United States
(12) Patent Application Publication
(10) Pub. No.: US 2010/0223285 A1
(43) Pub. Date: Sep. 2, 2010

(54) CRITICAL TEST RESULT MANAGEMENT SYSTEM AND METHOD

(76) Inventor: Brian Biddulph-Krentar, Exton, PA (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 12/769,170

(22) Filed: Apr. 28, 2010

Related U.S. Application Data
(63) Continuation-in-part of application No. 12/009,515, filed on Jan. 18, 2008.

(51) Int. Cl. G06F 17/30; G10L 11/00

(52) U.S. Cl. 707/769; 704/270.1; 707/E17.014; 704/E15.004

(57) ABSTRACT

A critical test results management system and method for capturing test data from a test results providing program and delivering messages to interested recipients. The system and method generating alerts, escalating the alerts to message receiving devices, and tracking the status of the alerts. The recipient of an alert can access the system to obtain the contents of the alert, acknowledge receipt of the alert, and record notes related to the alert. The invention tracks when alerts were sent and if they have been acknowledged. If the alerts are not acknowledge prior expiration of a predetermined time period, further alerts are escalated to the recipient, to different receiving devices, or to different recipients.

### CROSS-REFERENCES TO RELATED APPLICATION

This application is a continuation in part of U.S. patent application Ser. No. 12,009,515, which was filed on Jan. 16, 2008, which should be incorporated by reference in the present application.

### FIELD OF THE INVENTION

The present invention generally relates to an automated information delivery and management system and method. More particularly, the present invention relates to delivery of critical information, such as test results to an interested recipient in a timely manner and the management of the information before and after receipt. An example application of the present invention is in the healthcare industry.

### BACKGROUND OF THE INVENTION

In many industries timely delivery of critical information is paramount. Particularly, in all healthcare environments, when diagnosing and planning a patient's care plan, timing is critical. Thus, the availability of patient data is essential to all the appropriate caregivers, including, but not limited to, physicians, nurses, technologists and even administrators. In modern day health systems, the caregivers have an increasing amount of information available to help them make available better care for their patients. This abundance of patient data can also become a burden, especially when trying to timely manage the data.

Every healthcare environment struggles to deliver critical result notifications to the appropriate caregivers. Critical results warrant rapid communication. Timely delivery is vitally important. Quick and efficient communication of critical results can mean the difference between successful treatment and a disastrous outcome or simple, life or death. Poor, slow or inefficient communication of the critical results can lead to legal troubles and difficulty meeting regulatory challenges. Lack of effective and efficient communication can create frustration among patients and families and increases their fear and anxiety when they are already under a great deal of stress. Poor communication between the caregiver and the patient has a tendency to erode the trust in the caregivers, as well as the health care organization and thereby reduces patient satisfaction.

It is therefore desirable to have a system and method in place to improve the effectiveness and efficiency of the communication of critical test results among the caregivers and to more easily manage data, provide better care, and avoid legal and regulatory predicaments.

### SUMMARY OF THE INVENTION

The foregoing needs are met, to a great extent, by the present invention, wherein in one aspect a system and method are provided that in some embodiments messages regarding critical test results for a test subject to an interested recipient are delivered in a timely manner, and the information is managed before and after receipt.

In accordance with an embodiment of the present invention, a critical test results management system for capturing test data from a test results providing program and delivering messages to interested recipients includes a database for contact information, a computer, linked to the database, having, a communication device for receiving test data from the test results providing program and sending messages, an internal data transfer line connecting the components of the computer and transferring the test data between the components, a processor, connected to the internal data transfer line, for receiving test data, searching the test data for keywords or values, and for generating and sending messages to the communication device, and a receiving device for receiving messages from the communication device.

In accordance with another embodiment of the present invention, a critical test results management method for capturing test data from a test results providing program and delivering messages to interested recipients, involves receiving test data, parsing information from the test data, storing the parsed information in a database, analyzing the test data to generate a message, searching for recipient information for where to send the message, sending the message, and

confirming acknowledgement of receipt of the message within a set time period.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 shows a schematic view of a critical test results management system according to an embodiment of the present invention;

FIG. 2 shows a flowchart of alert creation and alert tracking in the critical test results management method according to an embodiment of the present invention;

FIG. 3 shows a flowchart of alert acknowledgment in the critical test results management method according to an embodiment of the present invention;

FIG. 4 shows a flowchart of alert acknowledgment via callback in the critical test results management method according to an embodiment of the present invention;

FIG. 5 shows a flowchart of alert acknowledgment via login in the critical test results management method according to an embodiment of the present invention;

FIG. 6 shows a flowchart of alert acknowledgment via telephony and voice translation in the critical test results management method according to an embodiment of the present invention;

FIG. 7 shows a flowchart of alert escalation in the critical test results management method according to an embodiment of the present invention; and

FIG. 8 shows a flowchart of contact management in the critical test results management method according to an embodiment of the present invention.

### DETAILED DESCRIPTION

Detailed embodiments of the present invention are disclosed herein; however, it is to be understood that the disclosed embodiments are merely illustrative of the invention that may be embodied in various forms. In addition, each of the examples given in connection with the various embodiments of the invention are intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

The critical test results management system and method can be configured such that it functions within the systems of a number of industries, for example, the healthcare field. The healthcare field will be used as an exemplary application for the critical test results management system and method, but it should be understood that this example is not limiting. The critical test results management system and method is configurable in order to integrate into any existing application, requiring the purchase of a specific vendor's remote installation services, picture archiving communication system, Lab, Pharmacy, Cardiology or other ancillary system. Further, the system and method is configurable to be compatible with Health Level 7 (HL7) standards. HL7 was founded in 1987 to produce a standard for hospital information systems and is accredited by the American National Standards Institute (ANSI). HL7 is one of several American National Standards Institute (ANSI) accredited Standards Developing Organizations (SDOs) operating in the healthcare arena. Most SDOs produce standards (sometimes called specifications or protocols) for a particular healthcare domain such as pharmacy, medical devices, imaging or insurance (claims processing) transactions. Health Level Seven's particular domain is clinical and administrative data, however, the critical test results management system and method is not tied to any specific department or application vendor and can be used across clinical areas throughout the enterprise.

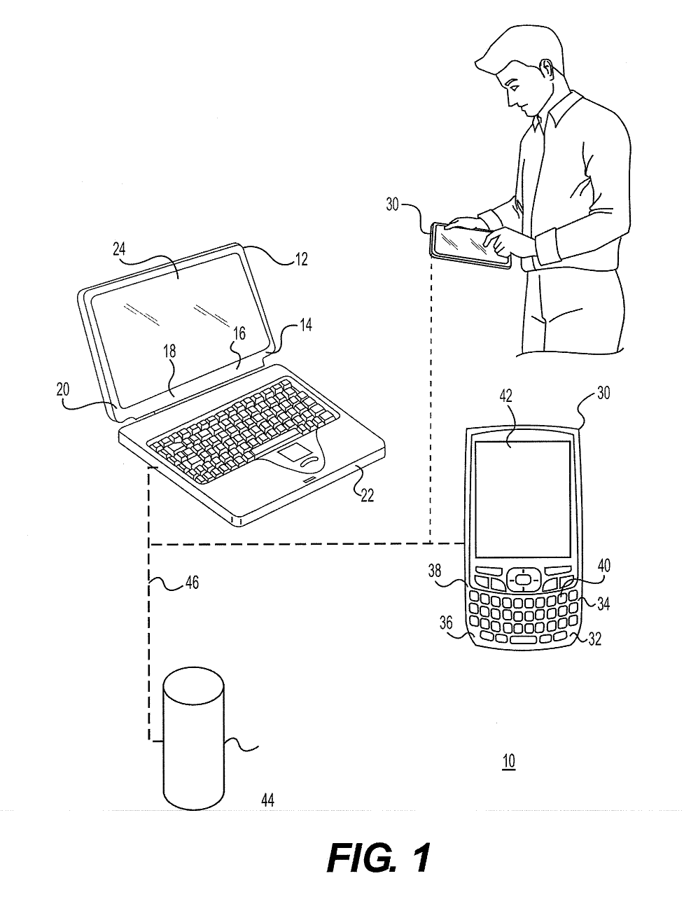

The invention will now be described with reference to the drawing figures, in which like reference numerals refer to like parts throughout. An embodiment of the of the present invention, a critical test results management system 10 for capturing test data from a test results providing program and delivering messages to interested recipients is illustrated in FIG. 1. Included in the critical test results management system 10 are a computing device 12 and a receiving device 30. The computing device 12 and receiving device 30 are capable of executing the test results management method explained below. Each of the computing device 12 and receiving device 30 may have a processor 14, 32, a memory 16, 34, a data link 18, 36, a communication device 20, 38, an input 22, 40, and a display 24, 42. The computing device 12 and receiving device 30 can be a general computer, such as a personal computer (PC), a Multi-Touch screen personal computing device, a UNIX or Solaris workstation, a server, a mainframe computer, a cloud computer, a personal digital assistant (PDA), a smartphone, or some combination of these. A smartphone.

In an alternate embodiment, the test data can be any time critical data in another. For example, an embodiment may be deployed in the financial industry to trigger an alert when a stock obtains a certain price level.

A smartphone is a mobile phone offering advanced capabilities, often with PC-like functionality (PC-mobile handset convergence). There is no industry standard definition of a smartphone, but there is a general consensus that a smartphone is a phone that runs an operating system software providing a standardized interface and platform. These features include, but should not be limited to e-mail, Internet, e-book reader capabilities, Wi-Fi, and/or a built-in full keyboard or external USB keyboard and VGA connector. In other words, it is a miniature computer that has phone capability.

Alternatively, the computing device 12 and receiving device 30 can be a specialized computing device. Another alternative allows the receiving device 30 to be a land line telephone, a voice over internet protocol (voip) telephone, cellular telephone or any voice communications link. Other components can include programming code, such as source code, object code or executable code, stored on a computer-readable medium that can be loaded into the memory 16, 34 and processed by the processor 14, 32 in order to perform the desired functions of the critical test results management system 10. The data link 18, 36 connects and allows of communication between all the components of the computing device 10 and the receiving device 30.

A database 44 for storing information may also be included in the critical test results management system 10. The database 44 can contact information for contact persons who are to receive alerts from the critical test results management system 10. The database 44 may include information such as a contact person identifier, specified receiving devices 30 to receive alerts, times of the day and days of the week for which the contact person can be reached on each receiving device 30. The database 44 and the computing device 12 are connected in a way that they can communicate with each other, possibly over a communication network 46.

In various embodiments, the computing device 12, the receiving device 30, and the database 44 can be communicate over a communication network 46, which can include any viable combination of devices and systems capable of linking computer-based systems, such as the Internet; an intranet or extranet; a local area network (LAN); a wide area network (WAN); a direct cable connection; a private network; a public network; an Ethernet-based system; a token ring; a value-added network; a telephony-based system, including, for example, T1 or E1 devices; an Asynchronous Transfer Mode (ATM) network; a wired system; a wireless system; an optical system; a combination of any number of distributed processing networks or systems or the like.

The computing device 12 and the receiving device 30 can be coupled to the communication network 46 by way of a communication device 20, 38, which in various embodiments can incorporate any combination of devices as well as any associated software or firmware configured to couple processor based systems, such as modems, network interface cards, serial buses, parallel buses, LAN or WAN interfaces, wireless or optical interfaces and the like, along with any associated transmission protocols, as may be desired or required by the design.

Additionally, an embodiment of the critical test results management system 10 can use a display 24, 42 to communicate information to a user, or contact person, and request input by way of an interactive, menu-driven, visual display-based user interface, or graphical user interface (GUI). The user interface can be executed, for example, on a personal computer (PC) with an input 22, 40, such as a mouse and keyboard, with which the user may interactively input information using direct manipulation of the GUI. Direct manipulation can include the use of an input 22, 40, pointing device, such as a mouse or a stylus, to select from a variety of selectable fields, including selectable menus, drop-down menus, tabs, buttons, bullets, checkboxes, text boxes, and the like. Nevertheless, various embodiments of the invention may incorporate any number of additional functional user interface schemes in place of this interface scheme, with or without the use of a mouse or buttons or keys, including for example, a trackball, a touch screen, telephone dial, or a voice-activated system.

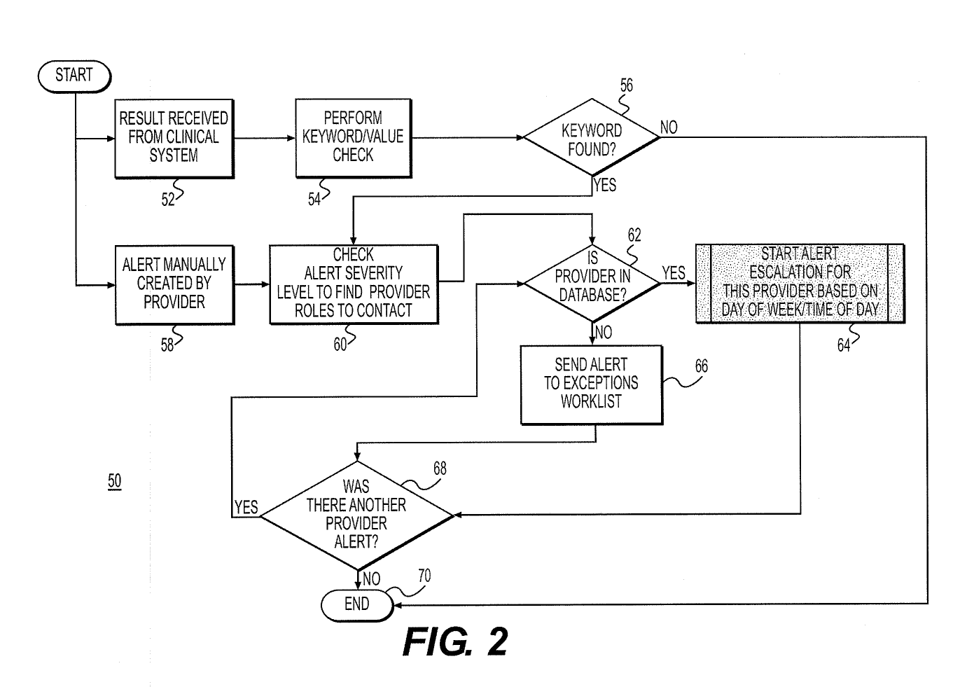

Another embodiment of the present invention is a critical test results management method. Referring now to FIG. 2, the critical test results management method includes an alert creation and alert tracking routine 50. A first embodiment of this routine includes receiving data from a system (step 52). The data could be formatted in compliance with HL7 standards. For example the data may include such HL7 data such as Admission, Discharge and Transfer (ADT) data, ORder Message (ORM) data, Observational Report-Unsolicited (ORU) data. The current invention can capture ADT data for the purpose of populating its database 44 with the required patient and visit information. ORM data can be captured and mapped for the purpose of populating the database 44 with the required exam, test, order information and/or updates. The ORU data can be captured and mapped for the purpose of populating the database 44 with the required results information. Following the receipt of the data, the method continues by searching and identifying keywords and values within the data (step 54).

The alert creation and alert tracking routine 50 determines if there is any pertinent information found in at data (step 56). If no pertinent information is found, the alert creation and alert tracking routine 50 ends (step 70). However, if a pertinent keyword or value is discovered, then the method will apply a configurable set of criteria to the incoming data, automatically determining a level of severity and if there is a contact person. In this example, the healthcare provider is correlated with the alert at step 60. The database 44 may also contain more than just one contact. For example, the database 44 can contain the healthcare provider and the patient's medical proxy as contacts for this level of alert. The database 44 can also specify the receiving device 30, such as an email capable device, a Multi-Touch screen personal computing device, a pager, a telephone, and SMS Text Message capable device, a fax and/or printer. Additionally, embodiments can include more than one receiving device 30 per alert. For example, the present embodiments can send an alert to a healthcare provider's Ipad®, Blackberry® and laptop computer. Furthermore, the healthcare provider or the contact entity may also have backup contacts listed in the database 44 in case of the primary contacts absence. As a failsafe, a default notification method can be listed to ensure an alert is acted upon. In event the acknowledgement by the contact was not received, the alert system could notify a doctor's answering service alerting the service that an alert needs to be acted upon.

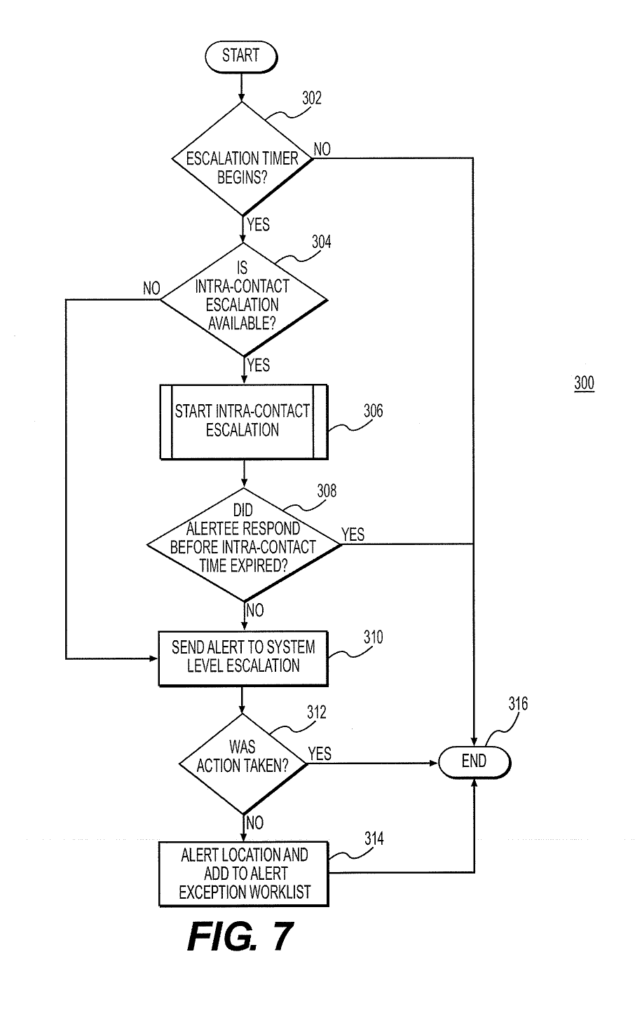

The alert creation and alert tracking routine 50 uses the severity level to match it with a contact in the database 44 (step 62). If a contact person is identified, the method starts the escalation routine 300 from FIG. 7 at step 64 of FIG. 2. If no contact person is identified, or if the contact information is missing for the person from the database 44, then an alert is sent to an exceptions worklist (step 66). Whether the escalation routine 300 is started (step 64) or an alert is sent to an exceptions worklist (step 66), the next step is to check for a further contact person (step 68). If no other contact person is specified, then the alert creation and alert tracking routine 50 ends (step 70). If a further contact person is specified, the contact person is searched for in the database 44 (step 62), and the alert creation and alert tracking routine 50 proceeds as above.

In another embodiment of the alert creation and alert tracking routine 50, the first step may be manually creating an alert (step 58). After creation of the alert, the alert creation and alert tracking routine 50 continues as above from step 60 onward.

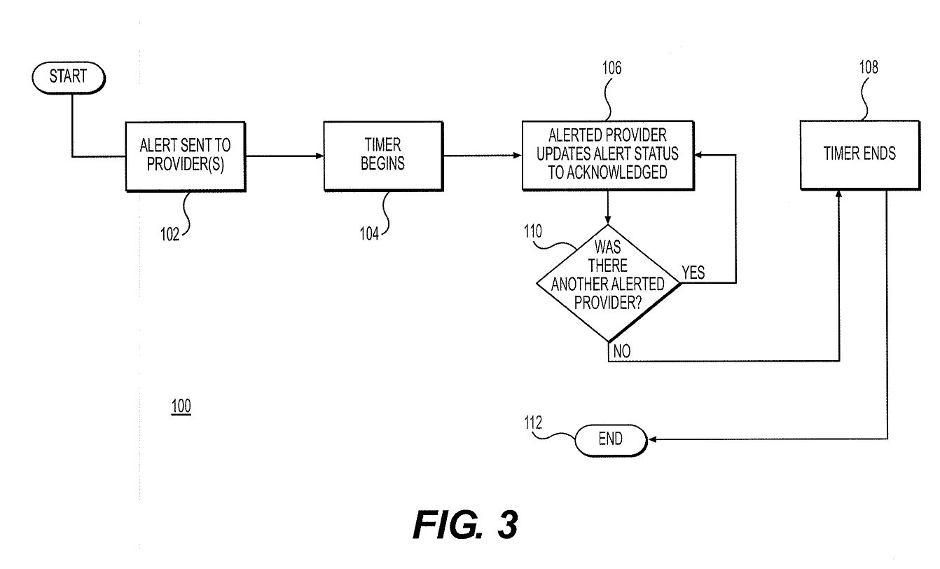

Referring now to FIG. 3, a further embodiment of the critical test results management method includes an alert acknowledgment routine 100. The alert acknowledgment routine 100 begins when the alert is sent to the contact person(s) intended to receive the alert on the intended receiving device (step 102). Once receipt is confirmed, a timer for each contact person for the alert begins at step 104. During the time for which the timer runs for this alert, the alert acknowledgment routine 100 will receive an update from the contact person that the alert is acknowledged (step 106). Once receiving the update of acknowledgement, the timer that contact person for the alert ends (step 108). At the same time the alert acknowledgment routine 100 checks to see if there were other contacts for the alert (step 110). If there were no other contacts, the alert acknowledgment routine 100 continues to the stop timer step (step 108). If there is another contact for the alert, the alert acknowledgment routine 100 waits for acknowledgement update (step 106) and continues as above. From the stop timer step (step 108) the alert acknowledgment routine 100 ends (step 112).

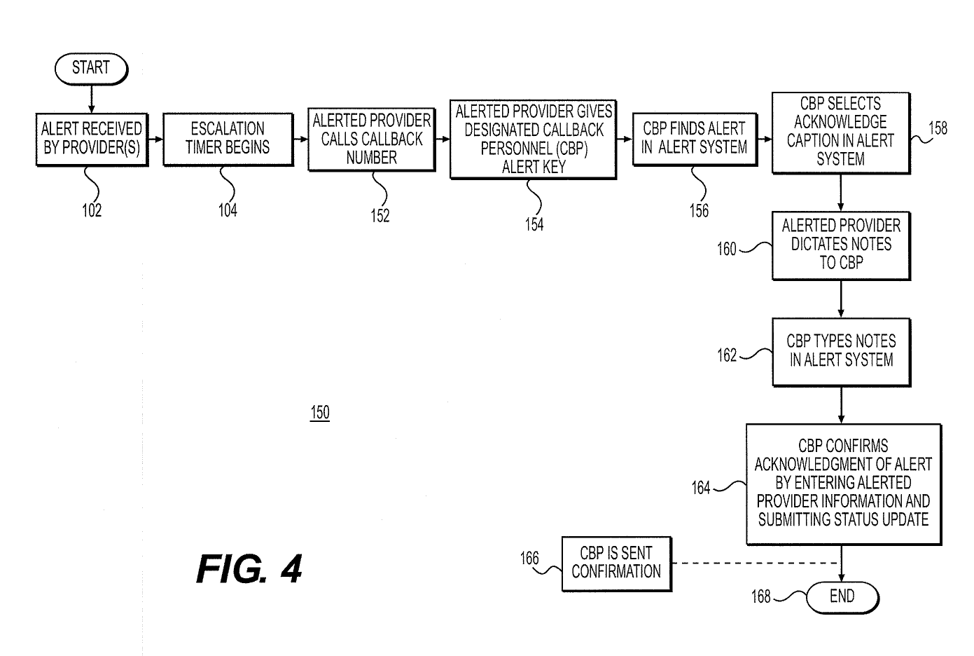

There are a number of ways the contact person can send an alert acknowledgement update. In one embodiment of the critical test results management method, referring now to FIG. 4, the contact person can initiate the alert acknowledgment via callback routine 150. The first steps are the contact person receiving a sent alert at the intended destination via the receiving device 30 (step 102). This starts a timer for the contact person for the alert (step 104) as discussed above in the alert acknowledgment routine 100. The alert received by the contact person contains a callback number and an alert key. The contact person calls the callback number (step 152) using a telephony device, such as a telephone or a cellular telephone. The call is received by designated callback personnel, and the contact person provides the designated callback personnel with the alert key (step 154). The designated callback personnel locates the alert using the alert key (step 156) and marks the alert acknowledged (step 158). The contact person then dictates notes to the designated callback personnel (step 160) and the designated callback personnel records the notes (step 160). The designated callback personnel confirms acknowledgement of the alert by recording the contact person's information and submitting a status update (step 164), and then ends the alert acknowledgment via callback routine 150 (step). In an alternative embodiment, the designated callback personnel can send a confirmation back to the contact person to their receiving device 30.

In some embodiments, the designated callback personnel may otherwise be an automated system configured to do the functions of the designated callback personnel in the alert acknowledgment via callback routine 150.

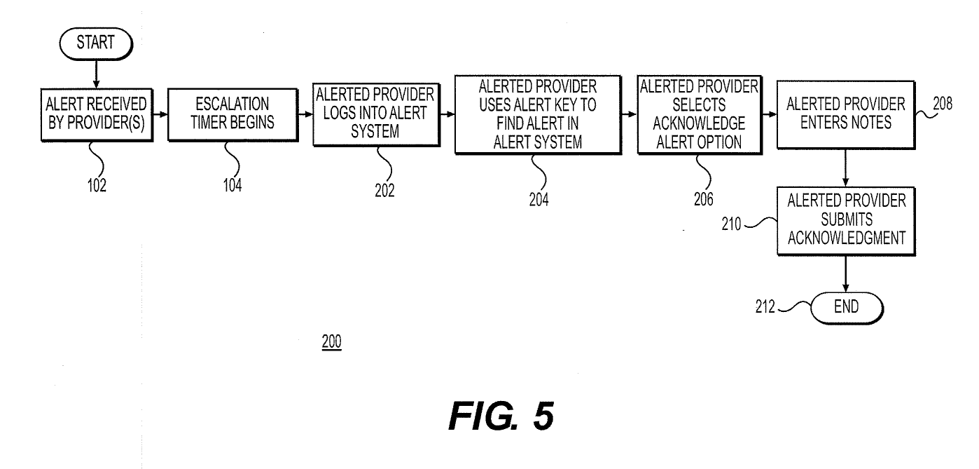

In another embodiment of the critical test results management method, referring now to FIG. 5, the contact person can initiate the alert acknowledgment via login routine 200. The first steps are the contact person receiving a sent alert at the intended destination (step 102) and starting a timer for the contact person for the alert (step 104) as discussed above in the alert acknowledgment routine 100. The alert received by the contact person contains an alert key. The contact person logs into the critical test results management system 10 (step 202) via some computing device, for example a personal computer, a laptop, an Ipad or a smartphone. The contact person finds the alert in the critical test results management system 10 by matching the alert key (step 204). To match the alert key, the contact person might search manually through a list of alerts to find the alert correlated with the alert key, or he may enter the alert key and allow the critical test results management system 10 to automatically search for the appropriate alert. The contact person then records that he acknowledges receipt of the alert (step 206) and further records notes for the alert (step 208). The contact person submits the acknowledgement and notes (step 210) and ends the alert acknowledgment via login routine 200 (step 212).

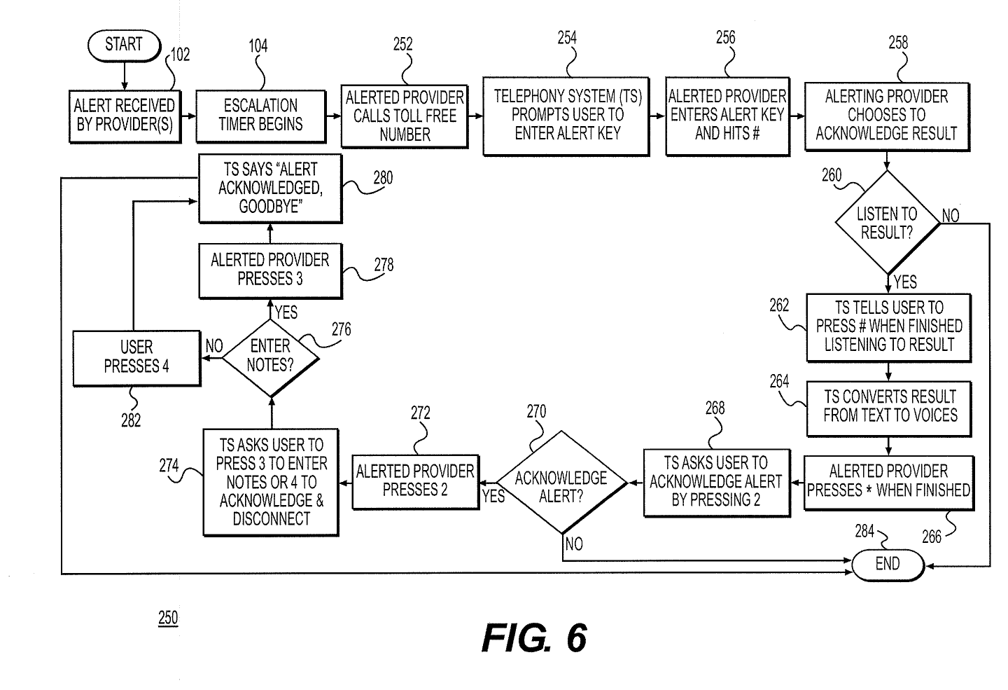

Now referring to FIG. 6, in another embodiment of the critical test results management method the contact person can initiate the alert acknowledgment via telephony and voice translation routine 250. The first steps are the contact person receiving a sent alert at the intended destination (step 102) and starting a timer for the contact person for the alert (step 104) as discussed above in the alert acknowledgment routine 100. The alert received by the contact person contains a callback number and alert key. The contact person calls the callback number (step 252) using a telephony device, such as a telephone or a cellular telephone. The callback number, for example, can be a which can be a toll free number or a toll number. An automated system, such as a telephony system, prompts the contact person to enter the alert key (step 254). The telephony system maybe an integrated element of the critical test results management system 10. The contact person then enters the alert key (step 256). The alert key may be entered using, for example, telephone touch keys or a touch screen equivalent, and the contact person may signal the end of the alert key by sending a designated signal, such as by pressing the pound key (#), also known as the hash key. The telephony system then records an acknowledgement of the test results related to the alert (step 258).

After recording the acknowledgement (step 258) the contact person is then given the option to listen to the alert (steps 260). If the contact person declines to listen the alert acknowledgment via telephony and voice translation routine 250 ends (step 284). If the contact person agrees to listening to the alert the telephony system instructs the contact person to indicate when he is done listening (step 262). The contact person may indicate he is done listening, for example, by sending a designated signal, such as by pressing pound key (#), also known as the hash key. The telephony system then communicates the text of the test results related to the alert in an audible format (step 264) and the contact person indicated that he is done listening (step 266). The contact person may also listen to any notes already recorded, either textually or audibly, for the alert. The contact person then is instructed to acknowledge the alert (step 268) and may do so, for example, by sending a designated signal, such as by pressing the “2” key.

The present embodiment will then instruct the contact person to acknowledge the alert (step 268), the telephony system checks to see if the contact person acknowledges the alert (step 270). If the contact person does not acknowledge the alert, then the alert acknowledgment via telephony and voice translation routine 250 ends (step 284). If the contact person does acknowledge the alert (step 272), then the telephony system gives the contact person the option to chose to enter notes, or acknowledge and disconnect (step 274). The contact person may chose one of the option, for example, by sending a designated signal, such as by pressing the “3” key to enter notes and pressing the “4” key to acknowledge and disconnect.

The telephony system checks to see what the contact person selects (step 276). If the contact person decides to enter notes, he makes the indication to enter notes and records his notes (step 278). The telephony system then gives the contact person a confirmation of the acknowledgement (step 280) and ends the alert acknowledgment via telephony and voice translation routine 250 (step 284). If the contact person decides to acknowledge and disconnect, he makes the indication to acknowledge and disconnect (step 282), the telephony system then gives the contact person a confirmation of the acknowledgement (step 280), and ends the alert acknowledgment via telephony and voice translation routine 250 (step 284).

An embodiment of the alert acknowledgment via telephony and voice translation routine 250 allows the critical test results management system 10 to track how much of the result is reviewed and how many times the result is reviewed.

In still yet another embodiment, an Interactive Voice Response (IVR) technology is deployed allowing critical test results management system to do both detect voice and dual-tone multi-frequency signaling (DTMF) keypad inputs. It will allows users to access a critical test results management system database via a telephone keypad or by speech recognition, after which they can service their own inquiries by following the instructions. IVR systems can respond with pre-recorded or dynamically generated audio to further direct users on how to proceed. IVR systems can be used to control almost any function where the interface can be broken down into a series of simple menu choices.

In yet another embodiment of the critical test results management method, any of the alert acknowledgment via callback routine 150, the alert acknowledgment via login routine 200, or the alert acknowledgment via telephony and voice translation 250 could be repeated from the point after the contact person initiates a response to an alert (i.e. step 152, step 202, and step 252) prior to ending any of the routines 150, 200, 250 (i.e. step 168, step 212, and step 284).

The critical test results management method may further include a alert escalation routine 300. In the context of the present application, escalation is the process of sending an alert to a destination. Once initiating the alert escalation routine 300 the first step is to determine if the timer, or escalation timer, started in step 104, has expired (step 302). If the timer has not expired, then the alert escalation routine 300 ends (step 316). If the timer has expired, then it is determined if intra-contact escalation is available (step 304). Intra-contact escalation will be described in more detail below. If intra-contact escalation is not available, then an alert is sent as defined in the default notification method (step 310). If intra-contact escalation is available, intra-contact escalation is initiated (step 306). Much like the escalation process, there is a timer for intra-contact escalated alerts, and it is determined if the contact person for the intra-contact alert was responded to before the intra-contact timer expired (step 308). If the intra-contact alert timer does not expire before a response, then the alert escalation routine 300 ends (step 316). If the intra-contact alert timer does expire before a response, then an alert is sent as defined in the default notification method (step 310).

The a default notification is a last measure of safety to ensure action in response to the alert. Such a notification may be an alert sent to a contact person who, at the time, is in a position to attend to the alert. An example of such a contact person may be an attending physician who is known to be at a hospital, or the nurses working at a nursing station in a hospital. After an alert is sent as defined in the default notification method (step 310), it is determined if any action was taken in response to the default notification (step 312). If action was taken in response to the default notification, then the alert escalation routine 300 ends (step 316). If no action was taken in response to the default notification, then the test result providers are alerted and the alert is added to the exceptions worklist (step 314), and the alert escalation routine 300 ends (step 316).

The critical test results management method makes use contact person profiles. The critical test results management method allows for creation and modification of the contact person profiles. Some information that the critical test results management method uses from the contact person profiles might include the device or contact method used to send an alert to the contact person depending on the day of the week or time of the day. The profiles might also be populated or modified by information imported from a source outside of the critical test results management system. For example, a medical practice could upload a schedule of which care provider is on call and the modes to contact that care provider.

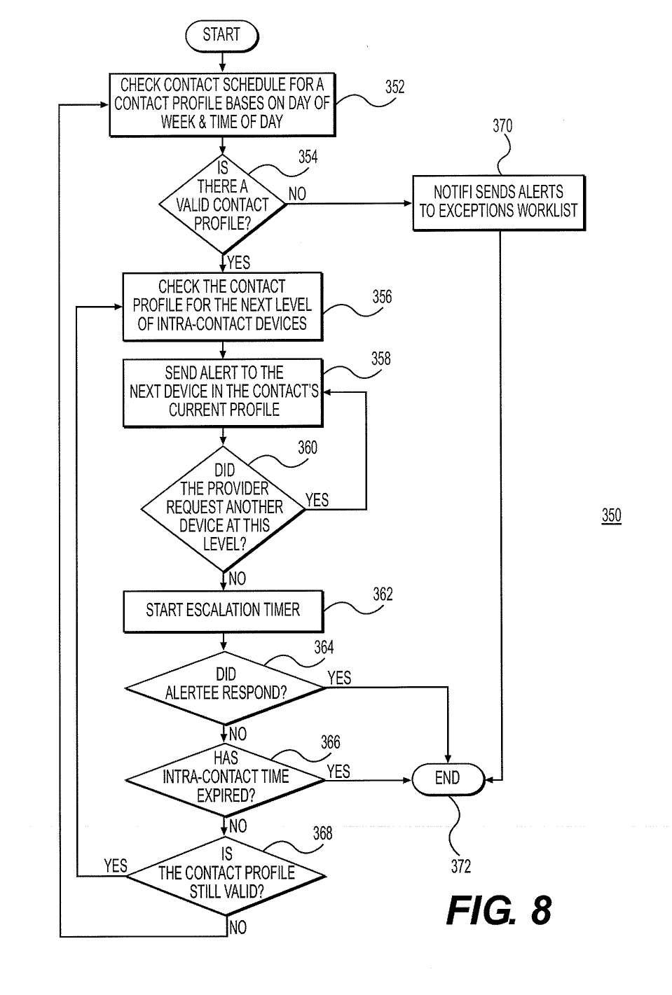

Now referring to FIG. 8, the contact management routine 350 may be included in an embodiment of the critical test results management method. The first step in the contact management routine 350 may be to check for a profile of a contact person that comports with the temporal situation at the time of sending an alert (step 352). It is determined if there is a valid profile for the temporal situation (step 354). If there is not a valid profile for the temporal situation, then the alert is sent to the exceptions worklist (step 370) and the contact management routine 350 ends (step 372). If there is a valid profile for the temporal situation, then the next level of intra-contact devices is sought (step 356) and an alert is sent to the device for the appropriate level in the profile (step 358). It is then determined if another device was specified for the level (step 360). If another device was specified an alert is sent to the device (step 358), otherwise the escalation timer is commenced (step 360). A determination is then made on whether there was response to the alert (step 364). If there was a response, then the contact management routine 350 ends (step 372). If no response was made, a determination is made in whether the intra-contact timer expired (step 366). If the intra-contact timer expired, then the contact management routine 350 ends (step 372), otherwise a check is made to determine if the profile for the contact person is still valid in the temporal situation. If the profile for the contact person is still valid, then the contact management routine 350 returns to step 356, otherwise a search for a valid profile is made (step 352).

In an additional embodiment, a manner of auditing changes to the contact person profiles may be provided. For example, such auditing may include use of the critical test results management system 10 and method. For example, the changes may include the modification of patient data, the order for the test, the result of the ordered test, and the alert data. Additionally, the modifications and deletions to the contact profile may not have been implemented by the user who implemented them. Therefore it is imperative that all changes to all databases in all embodiments have the date and time and the identification of the person implementing the original as an option.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A critical test results management system for capturing test data from a test results providing program and delivering messages to interested recipients, comprising:
a database component configured to store contact information;
a computer, communicatively connected to the database, having:
a communication device configured to receive test data from the test results providing program and send messages;
an internal data transfer link communicatively connected to the communication device and configured to transfer test data between the components of the computer;
a processor, communicatively connected to the internal data transfer link, configured to receive test data, search for keywords or values in the test data, and further configured to generate and send messages to the communication device; and
a receiving device configured to receive messages from the communication device.

2. The critical test results management system of claim 1, wherein said receiving device is a two way communication device capable of allowing a user to communicate with the critical test results management system.

3. The critical test results management system of claim 1, wherein said receiving device is a smart phone.

4. The critical test results management system of claim 1, wherein said receiving device is a Multi-Touch screen personal computing device.

5. The critical test results management system of claim 1, wherein said receiving device is a laptop computer.

6. The critical test results management system of claim 1, wherein said test data can be any time critical data.

7. The critical test results management system of claim 1, further comprising a timer which waits for an acknowledgement that a recipient has received the message.

8. The critical test results management system of claim 7, wherein said processor sends an escalated alert when said acknowledgement is not received after said timer has run out.

9. The critical test results management system of claim 1, wherein said message can be retrieved by an alerted user, further comprising:
a voice communication channel; and
an interactive voice recognition module.

10. The critical test results management system of claim 1 wherein said processor determines a type of alert to send to said communication device by a look up in said dataset.

11. A critical test results management method for capturing data from a test results providing program and delivering messages to interested recipients, comprising the steps of:
receiving data;
parsing information from the data;
storing the parsed information in a database;
analyzing the data to generate a message;
searching for recipient identification information for where to send the message;
sending the message; and
confirming acknowledgement of receipt of the message within a set time period.

12. The method for critical test results management of claim 9, further comprises providing access to the parsed information in the database comprises displaying data corresponding to the parsed information in a user interface and allowing a user to change the data via the user interface.

13. The method for critical test results management of claim 9, wherein said user interface is on a receiving device.

14. The critical test results management system of claim 13, wherein said receiving device is a smart phone.

15. The method for critical test results management of claim 9 further comprises:
starting a timer when the alert was sent;
waiting for an acknowledgement that a recipient has received the message; and
sending an escalated alert when said acknowledgement is not received.

16. A computer-readable medium having computer-executable instructions that, when executed, cause a computer system to perform operations for capturing data from a test results providing program and delivering messages to interested recipients providing, the operations including:
receiving data;
parsing information from the data;
storing the parsed information in a database;
analyzing the data to generate a message;
searching for recipient identification information for where to send the message;
sending the message; and
confirming acknowledgement of receipt of the message within a set time period.

17. The computer-readable medium of claim 16, the operations further providing access to the parsed information in the database comprises displaying data corresponding to the parsed information in a user interface and allowing a user to change the data via the user interface.

18. The computer-readable medium of claim 16, the operations further including starting a timer when the alert was sent and waiting for an acknowledgement that a recipient has received the message and sending an escalated alert when said acknowledgement is not received.

19. The computer-readable medium of claim 16, the operations further including determining which type of alert to send based upon data in said data base.

20. Apparatus for providing critical test results comprising:
means for receiving data;
means for parsing information from the data;
means for storing the parsed information in a database;
means for analyzing the data to generate a message;
means for searching for recipient identification information for where to send the message;
means for sending the message; and
means for confirming acknowledgement of receipt of the message within a set time period.
